(19) United States
(12) Patent Application Publication
(10) Pub. No.: US 2020/0238229 A1
(43) Pub. Date: Jul. 30, 2020

(54) WASTEWATER TREATMENT WITH INDEPENDENTLY CONTROLLED AERATION AND MIXING

(71) Applicant: Triplepoint Environmental LLC, Oak Park, IL (US)

(72) Inventor: Patrick D. HILL, Forest Park, IL (US)

(73) Assignee: Triplepoint Environmental LLC, Oak Park, IL (US)

(21) Appl. No.: 16/751,513

(22) Filed: Jan. 24, 2020

Related U.S. Application Data
(60) Provisional application No. 62/796,624, filed on Jan. 25, 2019.

(51) Int. Cl. B01F 3/04; B01F 13/02; B01F 15/00

(52) U.S. Cl. CPC B01F 3/04241; B01F 13/0266; B01F 15/00415; B01F 2215/0052; B01F 2003/04354; B01F 2003/04148; B01F 15/00344

(57) ABSTRACT

Fine-bubble-producing aeration units and large-bubble-producing (or other mechanical) mixing units are interspersed with each other in a given body of water to be treated. The two different types of units are independently controlled to independently regulate degrees of aeration and mixing in the given body of water.

### CROSS-REFERENCE TO RELATED APPLICATIONS

This application is based on and claims the priority benefit of U.S. Provisional Application 62/796,624 filed Jan. 25, 2019, the contents of which are incorporated herein by reference.

### BACKGROUND OF THE INVENTION

In the treatment of wastewater (e.g., sewage) in a lagoon, it is known to use aerators to increase oxygenation of the water to “feed” aerobic, waste-consuming or waste-converting bacteria and otherwise to aid in the breakdown of organic matter. Also, it is useful to create mixing within the water so that the bacteria, organic matter, and oxygen can be brought together in order to maximize the breakdown of organic matter.

It is known to use aeration systems that maximize oxygen transfer through fine bubble diffusion. However, purely fine-bubble systems may not generate optimal mixing for a particular situation, in which case organic solids can build up on the bottom of the lagoon. It is also known to use systems that promote mixing using larger bubbles that induce roiling or burbling movement of the water in the system. However, while provide better mixing than fine-bubble systems, such systems may not be very efficient at transferring oxygen to the water.

Furthermore, dual-action aerators, which provide both fine-bubble-based aeration and large-bubble-based mixing with a single unit, are known. There are, however, certain circumstances where such units might be unable to best serve the requirements of a given wastewater treatment facility or process.

### SUMMARY OF THE INVENTION

The present invention provides distinct or separate, independent fine-bubble-producing aeration units and large-bubble-producing or mechanical mixing units interspersed with each other within a given body of water to be treated. The given body of water may be an entire contained volume of water, e.g., an entire lagoon, or it may be just a distinct region within a larger overall body of water, such as a partially separated cell or chamber within a larger wastewater-treatment facility. Aeration using the fine-bubble-producing aeration units and mixing using the large-bubble-producing or mechanical mixing units are separately and independently controlled, e.g., at different times during the overall sewage treatment process, or simultaneously to independently effect optimal degrees of aeration and mixing for the particular waste-treatment process being conducted. Preferably, the aeration-causing and mixing-causing units are separately removable and easily portable.

There are several benefits to this approach to wastewater treatment. For example, because the fine bubble component is controlled separately, the oxygen transfer efficiency and rate can be adjusted and optimized as needed. In certain circumstances, the fine bubble system can even be shut off without fear of losing mixing, thereby saving energy. Additionally, the mixing rate and energy needed to produce mixing can also be controlled separately, allowing what is perhaps one of the largest costs associated with lagoon biological treatment—namely, mixing—to be optimized.

Because the fine bubble and mixing components are controlled separately, biological treatment of nitrogen can be easily optimized. In a nitrification mode, where high oxygen levels are needed to promote the conversion of ammonia to nitrate, the fine bubble component can be “ramped up” or “ramped down” as needed to control energy usage and process stability. In a denitrification mode, the fine bubble component can be turned off so that the dissolved oxygen levels can decrease enough for the nitrate to be converted to nitrogen gas. All the while, mixing is maintained and, as a result, the biological treatment is improved.

The portable nature of the fine bubble system allows the units to be serviced from the surface of the lagoon, without taking the lagoon offline and without losing mixing within the lagoon that would otherwise allow solids to settle during the maintenance process. The portable nature of the mixing equipment allows it to be removed for maintenance, while the rate of bubble production by the fine bubble system can be temporarily increased to mitigate the loss of mixing during this process.

In completely mixed activated sludge lagoons, the volume of air that needs to be supplied to the lagoon tends to be driven more by mixing requirements than by the need for oxygen transfer. As a result, the amount of air provided to the lagoon—and, by extension, the horsepower required to deliver that air—can be reduced while keeping sufficient biomass suspended in the water column for the activated sludge process to proceed.

Furthermore, for biological treatment of nitrogen in an activated sludge lagoon, high oxygen conditions are often followed by low oxygen conditions with mixing. With a system as per the invention, aerobic conditions to promote nitrification, i.e., conversion of ammonia into nitrate, followed by anoxic conditions—where low dissolved oxygen is preferred—to promote denitrification and convert nitrate to nitrogen gas can easily and efficiently be achieved.

### BRIEF DESCRIPTION OF THE DRAWINGS

FIG. 1 is a schematic plan view of an installation for independently controlling fine-bubble-producing aeration units and large-bubble-producing mixing units in accordance with this disclosure; and

FIGS. 2A and 2B are schematic side views of the installation illustrated in FIG. 1, illustrating operation in an aerobic mode and in an anaerobic mode, respectively.

### DESCRIPTION OF EMBODIMENTS

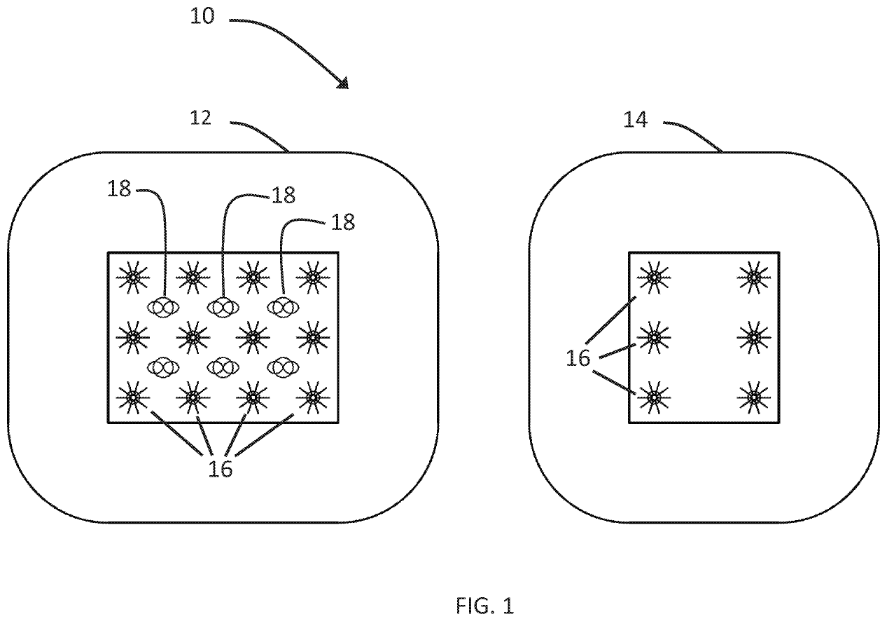

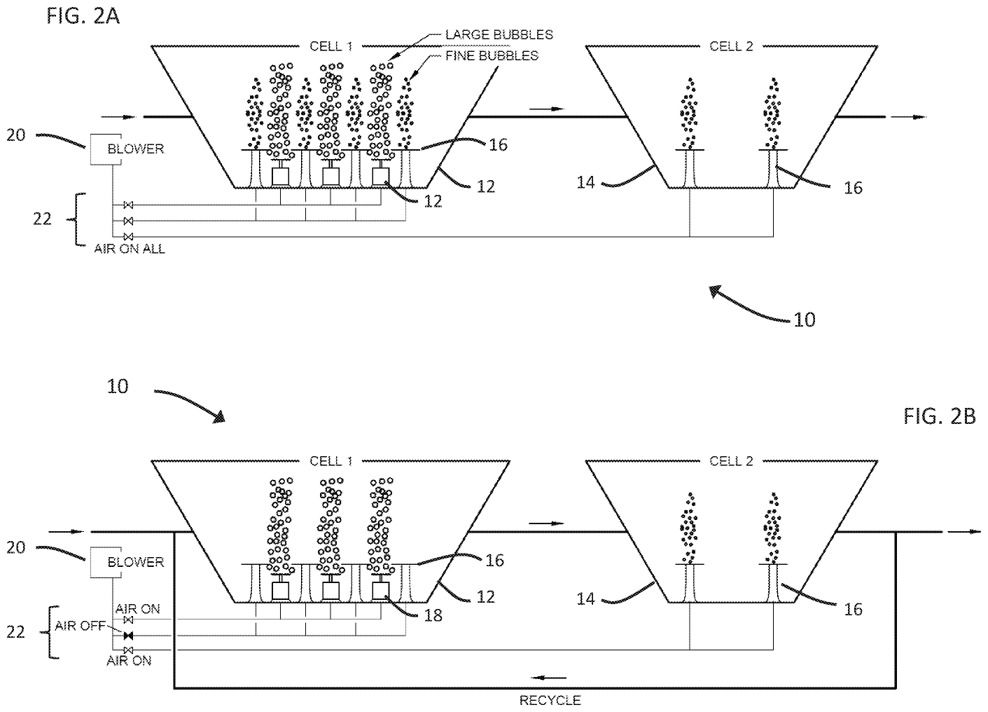

An embodiment 10 configured to practice the claimed invention is illustrated in FIGS. 1, 2A, and 2B. The embodiment 10 may be, for example, a wastewater treatment lagoon system, including a first, primary cell 12 in which aerobic nitrification and anaerobic denitrification take place depending on the operational mode of the cell 12; and a second, downstream polishing or clarifying cell 14 in which further aerobic nitrification takes place.

The primary cell 12 has a multitude of air-injecting units distributed across the floor of the cell, preferably interspersed with each other. The air-injecting units include fine-bubble-producing aeration units 16, which oxygenate the water and drive aerobic nitrification, and large-bubble-producing mixing units 18, which primarily drive mixing or turnover of water within the system. (Although some of the oxygen in the air released into the water column by the large-bubble-producing mixing units 18 will dissolve into the water column, the degree of dissolution will be at least an order of magnitude less than the degree of dissolution of oxygen in the air released into the water column by the fine-bubble-producing aeration units 16.) On the other hand, the downstream polishing or clarifying cell 14 has only fine-bubble-producing aeration units 16 distributed across the floor of the cell.

Suitably, the fine-bubble-producing aeration units 16 may each consist of several (e.g., four to six) wand-type tube diffusers, which are well known in the art, attached to and extending radially from a central air-supply hub. Other types of devices such as frits, perforated airline tubing, etc. are known to those having skill in the art and may be used instead of or in addition to tube diffusers. On the other hand, the large-bubble-producing units 18 may each be constructed rather simply, e.g., from a short length of pipe such as PVC pipe extending from an air-supply base.

One air-supply system provides air to the fine-bubble-producing aeration units 16 in each of the cells 12 and 14, and another air-supply system provides air to the large-bubble-producing mixing units 18 in the cell 12. As illustrated in FIGS. 2A and 2B, each of 1) the air-supply systems that provide air to the fine-bubble-producing aeration units 16 in the cells 12 and 14; and 2) the air-supply system that provides air to the large-bubble-producing mixing units 18 in the cell 12 may receive air from a common, central blower 20, with the amount of air delivered to each of the separate air-supply systems being independently regulated, e.g., by separate flow-control devices 22 (valves or flow-regulators) positioned downstream of the central blower and upstream of the respective sets of air-injecting units. Alternatively, in a configuration that is not illustrated, each of the separate air-supply systems may receive air from its own dedicated, independently controllable blower/valve arrangement.

As further illustrated in FIG. 2A, when the wastewater-treatment system 10 is operating in an aerobic, nitrifying mode of water treatment, air is supplied to both the fine-bubble-producing aeration units 16 and the large-bubble-producing mixing units 18 within the primary cell 12. In accordance with the claimed invention, the respective rates at which air is provided to the fine-bubble-producing aeration units 16 and the large-bubble-producing mixing units 18, e.g., in the primary cell 12, are independently controlled so that the rate of fine-bubble production via the fine-bubble-producing aeration units 16 and the rate of large-bubble production via the large-bubble-producing mixing units 18 are independently controlled. After a period of nitrification within the primary cell 12—which could be a fixed, predetermined period of time or a variable period of time that is as long as is required for all ammonia within the primary cell 12 to be reduced to nitrite and then to nitrate—partially treated wastewater is transferred to the polishing or clarifying cell 14, where it is further processed aerobically using fine-bubble-producing aeration units 16.

Once the wastewater has been nitrified, the system 10 is operated in an anaerobic, denitrifying mode as illustrated in FIG. 2B. During operation in this mode, air is no longer supplied to the fine-bubble-producing aeration units 16 in the primary cell 12, but air continues to be supplied to the large-bubble-producing mixing units 18 on an as-needed basis—e.g., following an on/off cycle—to turn over and mix the wastewater in the cell 12. Additionally, if desired, a portion of nitrified water can be “fed back” and supplied to the primary cell 12 from the polishing or clarifying cell 14 to foster denitrification in the primary cell 12. Doing so brings nitrified water that is high in nitrate to the “front” of the process, where denitrification can occur due to there being sufficient carbon (i.e. BOD) to drive down dissolved oxygen and give the denitrifying bacteria a source of food.

The foregoing description is of specific embodiments, and various modification to the disclosed embodiments will occur to those having skill in the art. For example, the illustrated embodiment uses large-bubble-producing mixing units to mix or turn over the water within the cell 12. However, mechanical mixing devices which use blades, vanes, impellers, or other stirring or pumping-type action can also be used, and the efficiency-maximizing, energy-saving benefits with respect to the cost to power such devices can still be obtained.

What is intended to be covered by Letters Patent is set forth in the following claims.

We claim:

1. In a wastewater treatment facility having fine-bubble-producing aeration units and mixing units interspersed with each other in a given body of water, the method comprising:
controlling a rate of fine-bubble production via the fine-bubble-producing aeration units; and
independently controlling a rate of mixing of water in the body of water using the mixing units.

2. The method of claim 1, wherein the mixing units comprise large-bubble-producing mixing units and wherein fine-bubble-based aeration and large-bubble-based mixing are conducted at different times with respect to each other.

3. The method of claim 2, wherein the fine-bubble-producing aeration units and the large-bubble-producing mixing units are supplied with air from a common source of air and wherein rates of air delivery to the fine-bubble-producing aeration units and the large-bubble-producing mixing units are independently controlled.
